(19) United States
(12) Patent Application Publication
(10) Pub. No.: US 2020/0096356 A1
(43) Pub. Date: Mar. 26, 2020

(54) METHOD FOR A USER/VEHICLE INTERFACE, AND USER/VEHICLE INTERFACE

(71) Applicant: HELLA GmbH & Co. KGaA, Lippstadt (DE)

(72) Inventors: Oliver KIRSCH, Wuppertal (DE); Tobias HEINE, Bamberg (DE)

(73) Assignee: HELLA GmbH & Co. KGaA, Lippstadt (DE)

(21) Appl. No.: 16/577,747

(22) Filed: Sep. 20, 2019

(30) Foreign Application Priority Data
Sep. 20, 2018 (DE) 10 2018 123 155.5

(51) Int. Cl. G01C 21/36; G10L 17/00; G10L 17/22

(52) U.S. Cl. CPC G01C 21/36; G10L 17/22; G10L 17/005

(57) ABSTRACT

A method for a user/vehicle interface of a vehicle, having an input unit for input of at least one user command of a user, an output unit for output of at least one selectable vehicle setting of the vehicle to the user, and a controller connected in a signal-transmitting manner to the input unit and to the output unit, wherein the at least one vehicle setting output by means of the output unit is selected by means of the controller as a function of the at least one user command entered by means of the input unit and implemented at least partially as a voice command. In order to further improve the operation of a user/vehicle interface of a vehicle by a user, a user identification unit for identification of the user and/or a driving condition identification unit for identification of a driving condition of the vehicle are additionally provided.

This nonprovisional application claims priority under 35 U.S.C. § 119(a) to German Patent Application No. 10 2018 123 155.5, which was filed in Germany on Sep. 20, 2018, and which is herein incorporated by reference

### BACKGROUND OF THE INVENTION

### Field of the Invention

The present invention relates to a method for a user/vehicle interface of a vehicle, a user/vehicle interface, a computer program product, and a computer-readable medium.

### Description of the Background Art

User/vehicle interfaces of this nature, methods for their use, computer program products, and computer-readable media are already known from the prior art in numerous embodiments.

For example, from DE 10 2008 059 810 A1 a control system for operating functions in a motor vehicle is known that includes an optical projection device for graphical reproduction of virtual display elements and/or virtual controls on an associated display area in the motor vehicle and a sensing device for sensing of control inputs upon actuation of the virtual controls. To simplify operation and improve road safety, related display elements and controls are selectable and displayable together. The selection of the display elements and controls to be displayed together is accomplished by means of a voice activation system, for example.

### SUMMARY OF THE INVENTION

It is therefore an object of the present invention to further improve the operation of a user/vehicle interface of a vehicle by a user.

This object is attained by a method for a user/vehicle interface, according to which the user/vehicle interface additionally has a user identification unit for identification of the user and/or a driving condition identification unit for identification of a driving condition of the vehicle, wherein the output of the at least one vehicle setting selectable by the user takes place as a function of the user identified by means of the user identification unit and/or of the driving condition identified by means of the driving condition identification unit.

Furthermore, this object is attained by a user/vehicle interface, according to which the user/vehicle interface additionally has a user identification unit for identification of the user and/or a driving condition identification unit for identification of a driving condition of the vehicle, wherein the controller is designed such that the output of the at least one vehicle setting selectable by the user takes place as a function of the user identified by means of the user identification unit and/or of the driving condition identified by means of the driving condition identification unit.

In addition, this object is attained by a computer program product and a computer-readable medium.

An important advantage of the invention resides, in particular, in that the operation of a user/vehicle interface of a vehicle by a user is further improved. By means of the user identification unit as well as the identification of the user and/or the driving condition identification unit as well as the identification of the driving condition of the vehicle, it is possible to significantly reduce the user's workload when the user/vehicle interface is utilized. Through utilization of the user/vehicle interface according to the invention, the user is distracted even less from controlling the vehicle and from observing the traffic situation. Because of the user identification unit as well as the identification of the user and/or the driving condition identification unit as well as the identification of the driving condition, it is possible to carry out selection of a particular vehicle setting, for example from a multiplicity of vehicle functions and with vehicle settings corresponding to the vehicle functions, largely automatically by means of the user identification and/or the driving condition identification, which is to say without the intervention of the user of the user/vehicle interface. The user's attention is now only required for a significantly smaller portion of the selection process than is otherwise usual. Accordingly, the demand on the user is reduced with use of the user/vehicle interface according to the invention, and the user is free for other tasks such as operating the vehicle and observing the traffic situation. The user can be the driver of the vehicle. This is not necessarily the case, however. Alternatively or in addition to the driver, at least one passenger of the vehicle can also be the user of the user/vehicle interface according to the invention. For example, when a user identification unit is present, it is possible that an occupant of the vehicle is automatically identified as the user by means of the user identification unit. Furthermore, it is possible that the user identification unit is multifunctional in design and, for example, not only identifies the user of the user/vehicle interface, but also identifies that person's location in the vehicle.

The user/vehicle interface can have a user identification unit for identification of the user and a driving condition identification unit for identification of a driving condition of the vehicle, wherein the output of the at least one vehicle setting selectable by the user takes place as a function of the user identified by means of the user identification unit and of the driving condition identified by means of the driving condition identification unit. Accordingly, an especially advantageous embodiment of the user/vehicle interface according to the invention provides that the user/vehicle interface has a user identification unit for identification of the user and a driving condition identification unit for identification of a driving condition of the vehicle, wherein the controller is designed such that the output of the at least one vehicle setting selectable by the user takes place as a function of the user identified by means of the user identification unit and of the driving condition identified by means of the driving condition identification unit. As a result, the advantageous effects of the invention explained above are further improved.

Fundamentally, the at least one selectable vehicle setting, and the output thereof by means of the output unit and the selection thereof by means of the input unit, is freely selectable by type and function within broad suitable limits. For example, the at least one selectable vehicle setting can be a multiplicity of vehicle settings. The vehicle settings in this case can correspond to only a single vehicle function or to a multiplicity of vehicle functions. The vehicle functions can relate, for example, to a seat, to a headrest, to a steering wheel, to entertainment media, to passenger-compartment lighting, to an air-conditioning system, and/or to a navigation device. This list is merely by way of example and is not exhaustive. The input unit here can be designed such that other forms of interaction between the user and the input unit are also made possible in addition to at least one voice command. For example, the input unit can also be designed for the input of at least one manual user command. The same applies analogously to the design of the output unit. For example, the output of the at least one selectable vehicle setting can be accomplished by means of a visual display. It is also possible, however, that the at least one selectable vehicle setting can be or is output audibly as an alternative or in addition thereto.

The output unit outputs a multiplicity of selectable vehicle settings in a previously defined sequence for selection as a function of the identified user and/or of the identified driving condition. In this way, it is possible that the more important vehicle settings or the vehicle settings that are selected frequently, for example by the specific detected user of the user/vehicle interface, are offered first to the user of the user/vehicle interface for selection and less important vehicle settings or vehicle settings that are selected less frequently are only offered afterward.

The previously defined sequence can be automatically determined by means of the controller as a function of at least one previously made selection of at least one vehicle setting. As a result, the previously defined sequence of the vehicle settings offered to the user for selection is not merely static, but instead is dynamic. Accordingly, the previously defined sequence of selectable vehicle settings is automatically adapted to changes in the behavior of individual users of the user/vehicle interface, for example.

The user can be identified on the basis of his speech. By this means, it is possible to realize the user/vehicle interface in an especially simple way, because both the input unit and the user identification unit function by means of speech. For example, it is possible to functionally combine the input unit with the user identification unit at least in part.

The user identification unit can be implemented as a voice identification unit. For example, it is possible to structurally combine the input unit with the user identification unit at least in part.

The driving condition can be identified by means of sensor data from at least one on-board sensor and/or navigation data from a navigation system. As a result, the identification of the driving condition of the vehicle can be achieved in an especially simple way. For example, sensor data relating to the driving condition of the vehicle are already available in the vehicle on account of the on-board sensor system existing in the vehicle independently of the user/vehicle interface according to the invention. Moreover, modern vehicles usually have a navigation device by means of which the current position of the vehicle can be determined automatically in interaction with a navigation system.

The driving condition identification unit can have at least one on-board sensor and/or a navigation system.

The driving condition can be identified by means of sensor data from at least one on-board sensor and navigation data from a navigation system. The automatic identification of the driving condition is further improved in this way. The same applies to an especially advantageous embodiment of the user/vehicle interface according to the invention in which the driving condition identification unit has at least one on-board sensor and a navigation system.

The user can select the at least one vehicle setting solely with voice commands, preferably solely with one single voice command. In this way, the user/vehicle interface required for the method according to the invention is simplified further. What is more, the selection of the at least one vehicle setting solely with one single voice command ensures that the workload of the user of the user/vehicle interface according to the invention is reduced as far as possible. It is possible, for example, that a multiplicity of vehicle settings, which can be associated with a single vehicle function or even a multiplicity of vehicle functions, can be selected simultaneously by means of the one single voice command.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which are given by way of illustration only, and thus, are not limitive of the present invention, and wherein the sole FIGURE illustrates an exemplary embodiment of a user/vehicle interface according to the invention.

### DETAILED DESCRIPTION

In the FIGURE, an exemplary embodiment of a user/vehicle interface according to the invention of a vehicle is shown by way of example. The vehicle is implemented as a motor vehicle, namely as an automobile, and is not itself shown. The user/vehicle interface has an input unit 2 implemented as a voice input unit for input of at least one user command of a user 3, an output unit 4 implemented as a visual output unit for output of at least one selectable vehicle setting of the vehicle to the user 3, and a controller 6 connected in a signal-transmitting manner to the input unit 2 and to the output unit 4. The input unit 2 is thus designed for input of at least one voice command and the controller 6 is designed for selection of the at least one vehicle setting output by means of the output unit 4 as a function of the at least one voice command.

In addition, the user/vehicle interface in the present exemplary embodiment has a user identification unit 8 implemented as a voice identification unit for identification of the user 3 and a driving condition identification unit 10 for identification of a driving condition of the vehicle, wherein the user identification unit 8 and the driving condition identification unit 10 are each connected in a signal-transmitting manner to the controller 6.

The driving condition identification unit 10 includes an on-board sensor 12 implemented as a speed sensor and an on-board navigation device 14 integrated into a navigation system in a manner known to the person skilled in the art and interacting with the same. Sensor data from the on-board sensor 12 and navigation data from the navigation system are merged in the driving condition identification unit 10 and analyzed to identify the driving condition. The merging and/or the analysis of the sensor data and the navigation data can also take place in the controller 6 itself, however. In this case, the driving condition identification unit 10 would be implemented as an integral component of the controller 6. The same applies analogously to voice data of the user identification unit 8 implemented as a voice identification unit and to the user identification unit 8 itself.

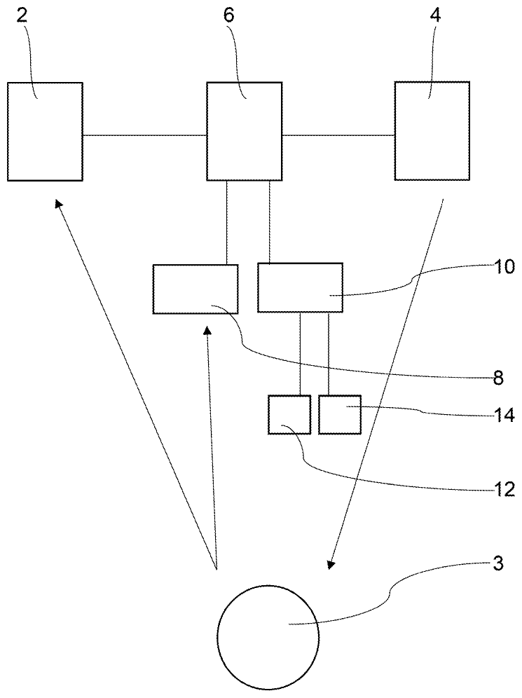

The method according to the invention is explained in detail below in accordance with the present exemplary embodiment on the basis of FIG. 1.

The user 3 of the user/vehicle interface, for example the driver of the vehicle or a passenger in the vehicle, has in advance entered a multiplicity of vehicle settings into the user/vehicle interface, namely into the controller 6 of the user/vehicle interface, in a manner known to the person skilled in the art. Entry of these vehicle settings takes place in a manner known to the person skilled in the art, for example by means of the input unit 2 of the user/vehicle interface. The vehicle settings can correspond in this case to only a single vehicle function or to a multiplicity of vehicle functions. The vehicle functions can relate, for example, to a seat, to a headrest, to a steering wheel, to entertainment media, to passenger-compartment lighting, to an air-conditioning system, and/or to a navigation device. This list is merely by way of example and is not exhaustive. In the present exemplary embodiment, the vehicle function relates to the tilt of a backrest of a driver's seat of the vehicle and the vehicle setting relates to a specific tilt of the backrest of the driver's seat during a driving condition of the vehicle implemented as highway travel. The driver's seat with the backrest is likewise not shown. A corresponding vehicle setting could also be entered in the same way and stored in the controller 6 for additional potential drivers of the vehicle.

The user 3, for example the driver of the vehicle, may have made the aforementioned vehicle setting, namely the specific tilt of the backrest of the driver's seat during highway travel of the vehicle, ahead of time, for example with the vehicle parked. If the user 3, which is to say the driver of the vehicle, is now driving the vehicle, then specifically this user 3 is identified on the basis of his speech by means of the user identification unit 8. Also, the specific driving condition of the vehicle at a specific point in time or in a specific period of time during travel with the vehicle is identified by means of the driving condition identification unit 10.

For example, during travel a specific person is identified on the basis of his speech as the current user 3 of the user/vehicle interface of the vehicle. It is also possible, however, that the user identification unit additionally has a camera or the like, by means of which this user 3 of the user/vehicle interface is simultaneously identifiable as the driver sitting in the driver's seat. For example, the camera can be implemented as an interior camera of the vehicle. Such interior cameras are already widespread in modern vehicles, so this interior camera can be used for the user identification unit at the same time as for its original function.

In addition, the driving condition identification unit 10 identifies the current driving condition of the vehicle on the basis of the on-board sensor 12 and the navigation system with the on-board navigation device 14. By means of the sensor data from the on-board sensor 12 and the navigation data from the navigation system, it can be detected, for example, that the vehicle is currently driving on a highway. Accordingly, the driving condition of the vehicle is identified by means of the driving condition identification unit 10 as highway travel of the vehicle.

By means of the above-mentioned automatic identification of the user 3 through the user identification unit 8, namely of the specific user 3, and the above-mentioned automatic identification of the current driving condition of the vehicle through the driving condition identification unit 10, namely the highway travel of the vehicle, the vehicle setting that is relevant for the specific user 3 and for the current driving condition of the vehicle is offered by means of the controller 6 through the output unit 4 to the user 3 for selection automatically, which is to say without effort on the part of the user 3 or a passenger of the vehicle.

In the present exemplary embodiment, provision is made that only one single vehicle setting is offered for selection to the relevant user 3 identified by means of the user identification unit 8 in the relevant driving condition of the vehicle identified by means of the driving condition identification unit 10. Accordingly, it is possible in the present exemplary embodiment that the user 3 can select this vehicle setting by means of a single voice command. The user 3 can thus select the offered vehicle setting with only a single voice command, for example a simple “yes” or the like.

Accordingly, the user 3 in the current driving condition of the vehicle, namely the highway travel of the vehicle, is offered for selection only the vehicle setting that the tilt of the backrest of the driver's seat can be transferred into the tilt specified in advance for highway travel of the vehicle by means of a single voice command, for example by a simple “yes” on the part of the user 3.

Thus, the aforementioned vehicle setting is offered to the user 3 for selection through the output unit 4 implemented as a visual output unit. For example, the message appears on the output unit 4 that the user 3 can set the tilt of the backrest of the driver's seat to be suitable for highway travel through the voice command “yes.” Once the user 3 has confirmed this visual message through a spoken “yes” by means of the input unit 2, the controller 6 activates an electric drive of the driver's seat, for example, such that its backrest is automatically moved into the tilt stored in advance for highway travel.

It is also possible, however, that the output unit 4 is not implemented as a visual output unit, but instead as an audible output unit. Accordingly, the abovementioned message would be issued audibly. A combination of a visual and an audible message is also possible. In this case, the output unit would be implemented as both a visual and an audible output unit.

The invention is not limited to the present exemplary embodiment. For example, the method according to the invention, the user/vehicle interface according to the invention, the computer program product according to the invention, and the computer-readable medium according to the invention can also be used advantageously with other vehicles. Furthermore, the at least one vehicle setting is not limited to the vehicle function of the seat. The at least one vehicle function can relate, for example, to a seat, to a headrest, to a steering wheel, to entertainment media, to passenger-compartment lighting, to an air-conditioning system, and/or to a navigation device. This list is merely by way of example and is not exhaustive. Consequently, more than a single selectable vehicle setting can also be output by means of the output unit and selected through the input unit as a function of the user identified by means of the user identification unit and/or of the driving condition identified by means of the driving condition identification unit.

Accordingly, another advantageous embodiment of the method according to the invention provides that the output unit outputs a multiplicity of selectable vehicle settings in a previously defined sequence for selection as a function of the identified user and/or of the identified driving condition. It is especially advantageous when the previously defined sequence is automatically determined by means of the controller as a function of at least one previously made selection of at least one vehicle setting. The selection of the at least one selectable vehicle setting can also be accomplished by means of a multiplicity of voice commands and also by means of at least one voice command and at least one user command that is not implemented as a voice command.

It is also possible that the input unit includes a steering wheel of the vehicle or other components of the vehicle for haptic user commands.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for a user/vehicle interface of a vehicle, comprising an input unit for input of at least one user command of a user, an output unit for output of at least one selectable vehicle setting of the vehicle to the user, and a controller connected in a signal-transmitting manner to the input unit and to the output unit, the method comprising:
selecting via the controller the at least one vehicle setting output by means of the output unit as a function of the at least one user command entered by means of the input unit and implemented at least partially as a voice command; and
identifying, via a user identification unit, an identification of the user and/or via a driving condition identification unit, a driving condition of the vehicle,
wherein the output of the at least one vehicle setting selectable by the user takes place as a function of the user identified by the user identification unit and/or of the driving condition identified by the driving condition identification unit.

2. The method according to claim 1, wherein the output unit outputs a plurality of selectable vehicle settings in a previously defined sequence for selection as a function of the identified user and/or of the identified driving condition.

3. The method according to claim 2, wherein the previously defined sequence is automatically determined by the controller as a function of at least one previously made selection of at least one vehicle setting.

4. The method according to claim 1, wherein the user is identified on the basis of his speech.

5. The method according to claim 1, wherein the driving condition is identified by sensor data from at least one on-board sensor and/or navigation data from a navigation system.

6. The method according to claim 1, wherein the user selects the at least one vehicle setting solely with voice commands, preferably solely with one single voice command.

7. A user/vehicle interface of a vehicle, comprising:
an input unit for input of at least one user command of a user;
an output unit for output of at least one selectable vehicle setting of the vehicle to the user; and
a controller connected in a signal-transmitting manner to the input unit and to the output unit, wherein the input unit is designed for input of at least one voice command and the controller is designed for selection of the at least one vehicle setting output by means of the output unit as a function of the at least one voice command; and
a user identification unit to identify the user and/or a driving condition identification unit to identify a driving condition of the vehicle,
wherein the controller is designed such that the output of the at least one vehicle setting selectable by the user takes place as a function of the user identified by the user identification unit and/or of the driving condition identified by the driving condition identification unit.

8. The user/vehicle interface according to claim 7, wherein the user identification unit is implemented as a voice identification unit.

9. The user/vehicle interface according to claim 7, wherein the driving condition identification unit has at least one on-board sensor and/or a navigation system.

10. A computer program product, comprising commands that cause a user/vehicle interface to carry out the method steps of the method according to claim 1.

11. A computer-readable medium on which the computer program product according to claim 10 is stored.
